(19) United States
(12) Patent Application Publication
(10) Pub. No.: US 2018/0200600 A1
(43) Pub. Date: Jul. 19, 2018

(54) MOUNTING BOARD

(71) Applicant: Allan TISO, Fallbrook, CA (US)

(72) Inventor: Allan TISO, Fallbrook, CA (US)

(21) Appl. No.: 15/921,574

(22) Filed: Mar. 14, 2018

Related U.S. Application Data
(63) Continuation-in-part of application No. 15/379,303, filed on Dec. 14, 2016.

(51) Int. Cl. A63B 71/00; F16B 17/00

(52) U.S. Cl. CPC A63B 71/00; F16B 17/00

(57) ABSTRACT

A mounting board with multiple openings to receive an expanded object in each opening. Each opening includes radial projections to frictionally engage an object with an interference fit. A size gauge is provided to assist in inflating the objects to a proper size to be engaged by the radial projections when an object is inflated and inserted into an opening. A one-way valve can be provided for ease of inflating the object and retaining the object in an inflated condition until it is hit by a projectile.

### FIELD OF INVENTION

This apparatus relates generally to multiple-object retaining structures, or mounting boards, and more particularly to such an arrangement having positive elements for holding each object in place, and having a gauge to enable each object to be expanded to a precise size in relation to the openings in the board.

### DISCUSSION OF THE PRIOR ART

Boards or supports to which one or more flexible, expanded objects are mounted, typically in relation to a game where scores are achieved, have been known. In some cases an object such as a balloon is burst upon contact, for example, with a dart or other projectile. In others a blunt object or projectile forces the inflated balloon against a sharp point to result in the balloon being exploded. There are many other mounting boards involving openings in a board surface which do not involve balloons.

In some cases objects may be inflated to a desired pressure or to a desired approximate size. In the case of the objects being balloons, the neck of the balloon must be tied off in some manner to prevent air from escaping too rapidly.

### SUMMARY OF EMBODIMENTS OF THE INVENTION

Among its purposes, the present apparatus includes a support device or mounting board and a gauge to enable the flexible, expanded objects to be inflated to a predetermined size or main-body diameter to fit into openings in the board which are equipped with positive object engagement elements.

In an alternative embodiment in which the objects are balloons, a conventional air valve, for example, a Schrader valve, is mounted in each balloon filling neck prior to its being inflated. The valve performs its normal function of allowing air in and preventing air from leaking out. The valve is then easily retrieved after the balloon is burst in cases where bursting of balloons is the purpose of the activity.

The support device for holding multiple objects in predetermined positions can be formed in a manner that allows it to be flat and compact prior to use, that is, prior to being fitted with expanded objects.

### BRIEF DESCRIPTION OF THE DRAWING

The objects, advantages, and features of this apparatus will be more clearly perceived from the following detailed description, when read in conjunction with the accompanying drawing, in which:

FIG. 1 is a perspective view of a mounting board with flexible, expanded objects mounted thereto in accordance with an embodiment of the present invention;

FIG 2. is a plan view of the board of FIG. 1 without the expanded objects mounted to it;

FIG. 3A is an enlarged plan view of a single opening in the board of FIG. 2;

FIG. 3B is an enlarged plan view of a size gauge for objects to be inflated to fit in the opening of FIG. 3A;

FIG. 4 is a partial plan view of the board of FIG. 2 with the gauge of FIG. 3B connected thereto;

FIG. 5 is an enlarged back side perspective view of an expanded balloon in an opening of the board of FIG. 1;

FIG. 6 is a partial plan view of an opening and a size gauge as part of the board;

FIG. 7 is a partial plan view of the board of FIG. 2 with alternative hole shapes;

FIG. 8 is an alternative perspective view similar to FIG. 1, without the expanded objects, showing different size objects openings;

FIG. 9 is a single exemplary balloon fitted with a valve to assist in inflating the balloon; and

FIG. 10 is a perspective view of a mounting board in accordance with an alternative embodiment of the present invention.

### DETAILED DESCRIPTION OF EMBODIMENTS OF THE INVENTION

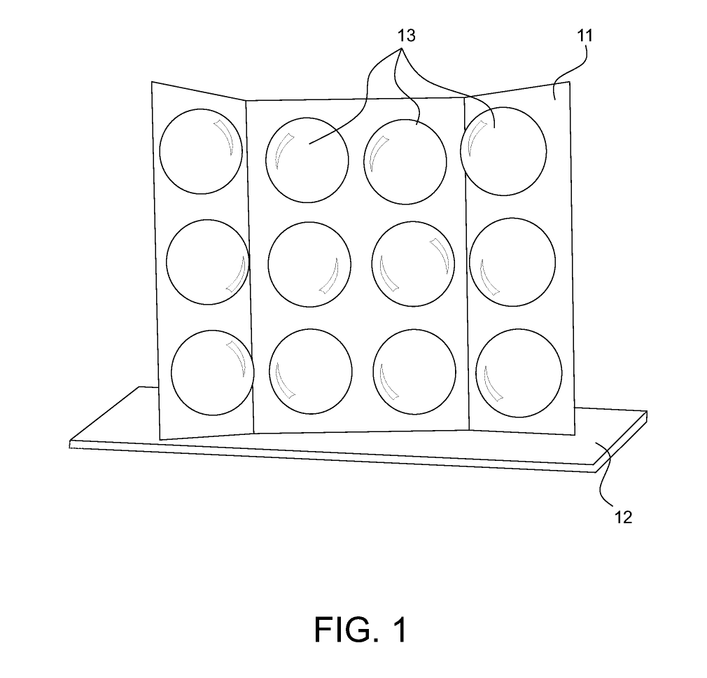

With reference to the drawings, and more particularly to FIG. 1, there is shown a foldable board 11 resting on a surface 12 in a free standing arrangement. Mounted in openings in the board are a plurality (twelve in this case) of flexible, expanded objects, such as balloons 13. There is no practical limitation of the size and number of objects this target set up may have. It could be larger or smaller, or it could be arranged to hold more or fewer objects.

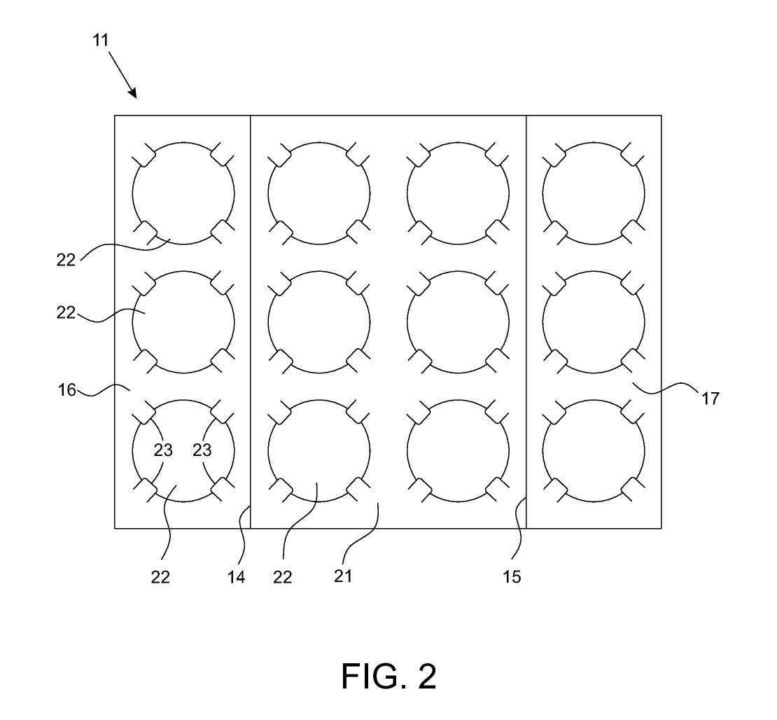

Board 11 may have three panels as shown, which enable it to fold flat for convenience. However, while being folded flat is preferred, the support need not be foldable. It could be a single, relatively rigid board which could be mourned on a convenient stand, on a wall, hung from a rod, or mounted on any appropriate element or device. It could also have more than three panels with the side panels folding over the center panel. See FIG. 2 for a three-panel embodiment, showing fold score lines 14, 15, with panels 16 and 17 being foldable onto center panel 21.

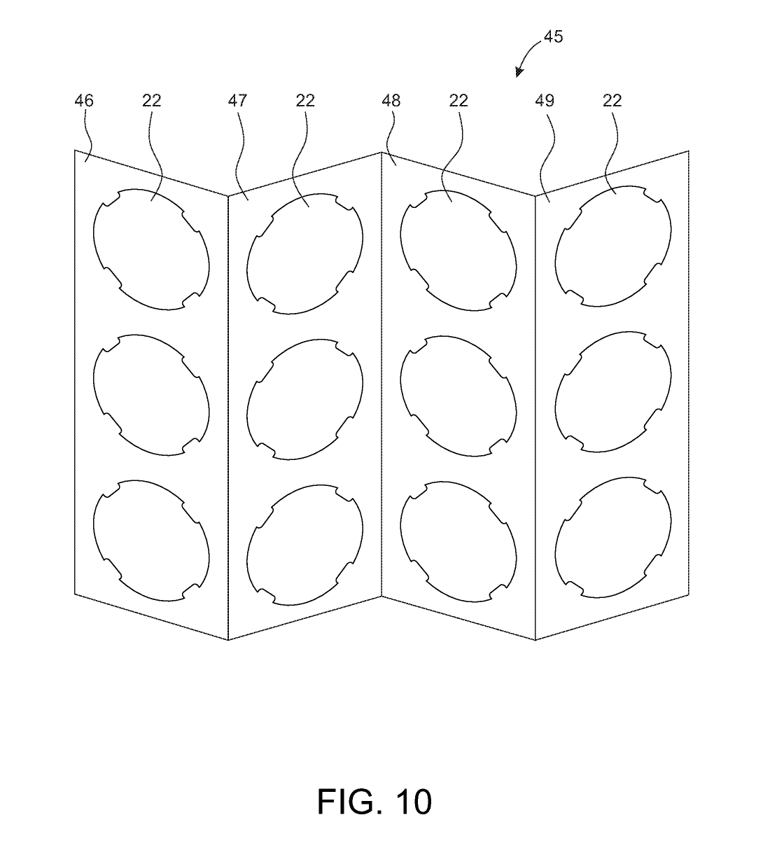

Board 11 could be formed of more than three panels with more than two fold lines, and still be able to be folded reasonably flat. An example of such a structure 45 is shown in FIG. 10, which is formed as a “W” or “M” with panels 46, 47, 48, and 49 foldable upon each other. More than four panels, or as few as two panels, or even a single panel, may form the board.

Openings 22 are sized for a particular inflated or expanded object, which may be a balloon. A convenient size is nine inches in diameter, which fits a common size balloon. It is desired that balloons be inflated to a reasonable inflation pressure or stress size so that a relatively loud pop is heard when the balloon bursts or explodes. Suitable balloons are typically made of rubber, but they can be any material that readily explodes when pierced after being inflated to a pressure which leads to a readily audible pop. While one purpose of a board with multiple objects 13 may be to achieve bursting with a loud report, busting of a need not be the only purpose of the board with objects mounted thereto.

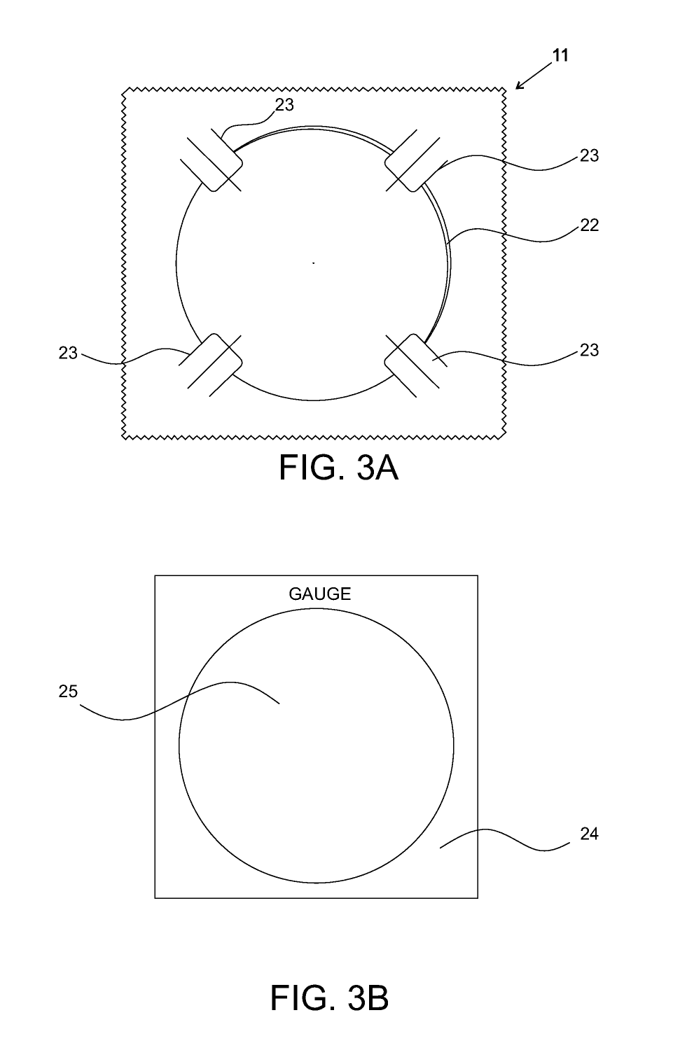

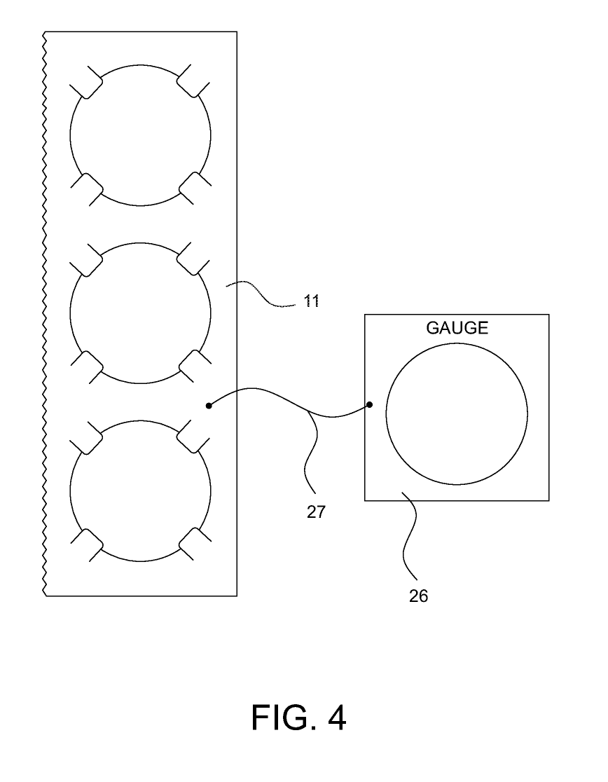

With reference to FIGS. 2 and 3A, it can be seen that there are several articulated wedge members or fingers 23 arranged around openings 22. The material of board 11 is contemplated to be a relatively stiff cardboard. However, it could be made of any material, including plastic or metal, that has sufficient rigidity to stand on its own in one embodiment, as shown in FIG. 1, and has sufficient flexibility so that undercut fingers 23 bend when engaged by the surface of a flexible, inflated object without puncturing the object. If the board is intended to be mounted on a wall or other structure, or hung from a rod, it need not have stiffness or rigidity to enable it to stand on its own.

In order to quickly and efficiently inflate an object such as a balloon to the proper size for an interference fit in openings 22, gauge 24 (FIG. 3B) is provided. The gauge is formed with opening 25 that is slightly larger in diameter than is opening 22. For a nine-inch opening 22, opening 25 in gauge 24 would be about 9.25 inches in diameter. These are exemplary dimensions only.

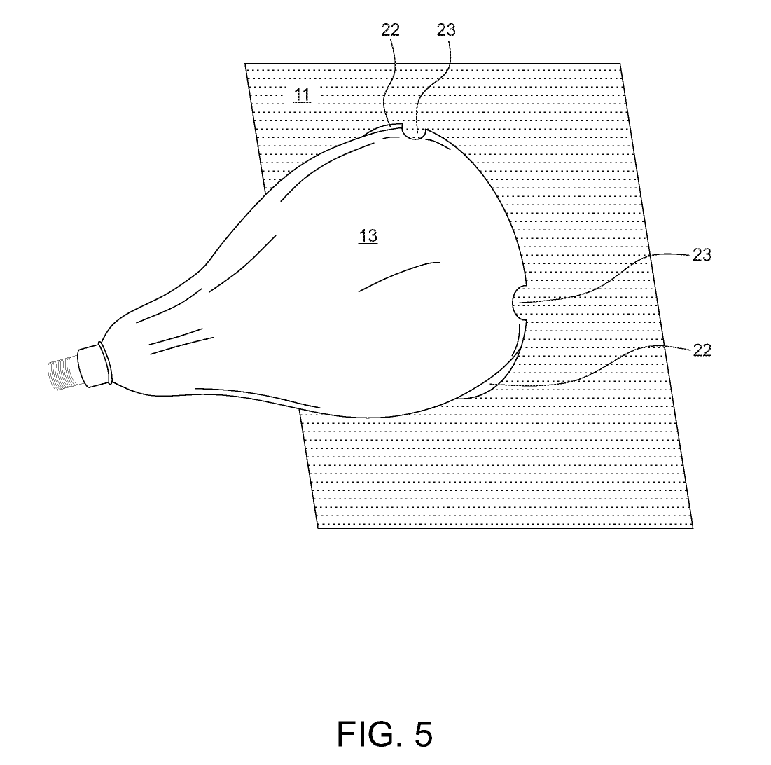

When object 13 is urged into opening 22 from the back side of board 11, as shown in FIG. 5, fingers 23 bend a small amount and the wall of the object flexes a small amount. Once the object is mounted in an opening 22, it is held firmly by a combination of friction and the very small amount of biting action into the object wall by fingers 23. As an alternative, small projections 42 into openings 41 are shown in FIG. 7, in place of fingers 23 in openings 22 in FIG. 2.

Gauge 24 is shown as a separate element in FIG. 3B. However, as shown in FIG. 4, gauge 26 can be connected, permanently or removably, to board 11 by tether 27. Tether 27 may be any type of flexible or bendable strip, string, strap, or thong.

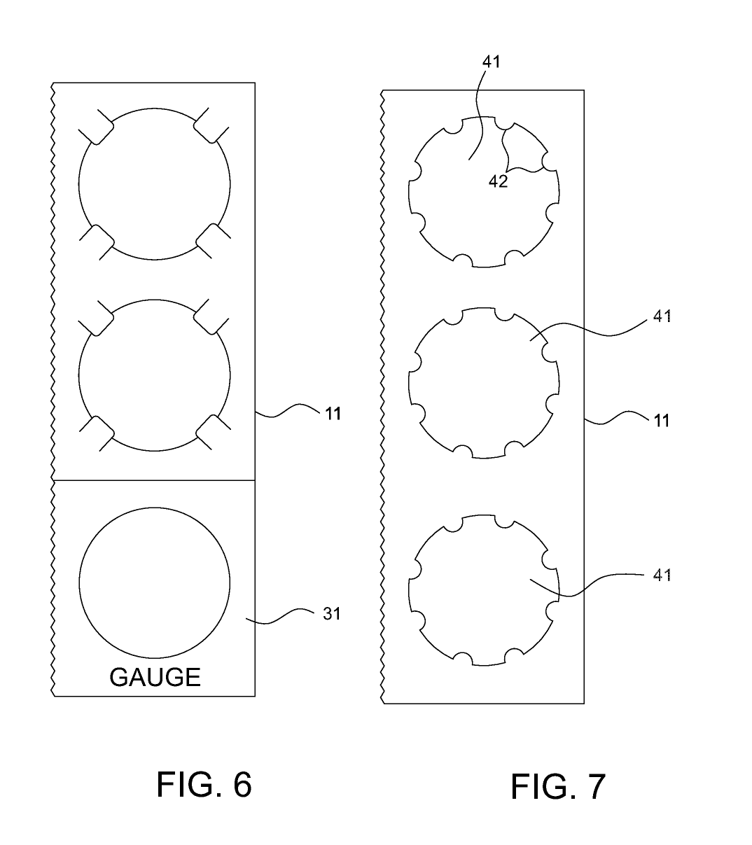

Alternatively, a gauge 31 may be formed integrally with board 11, as shown in FIG. 6. In this arrangement, one space that would otherwise be for receiving an object, is dedicated to providing the desired gauge function.

Another alternative is that a further flap or panel may be attached to panel 16 or panel 17 (see FIG. 2), which incorporates a gauge of the type shown in FIGS. 4 or 6, without using one of the object opening positions for the gauge.

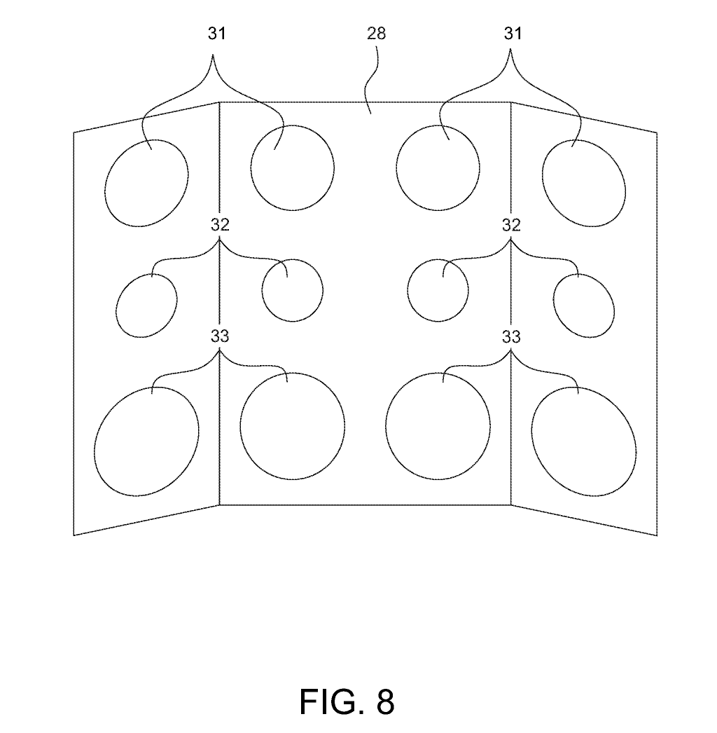

FIG. 8 shows that flexible, expandable object-retaining openings may have different sizes to accommodate larger or smaller, or both, objects. This figure is to suggest that openings 32 in the middle row of target board 28 may be a smaller size than openings 31 in the top row, and openings 33 in the bottom row may be larger than openings 31. When the device is used as a game, each different size object or balloon may be assigned a different point value. When the target device is used for shooting practice the shooter might choose to aim at the largest balloons first, go to the medium size balloons second, and then aim to burst the smaller balloons in openings 32.

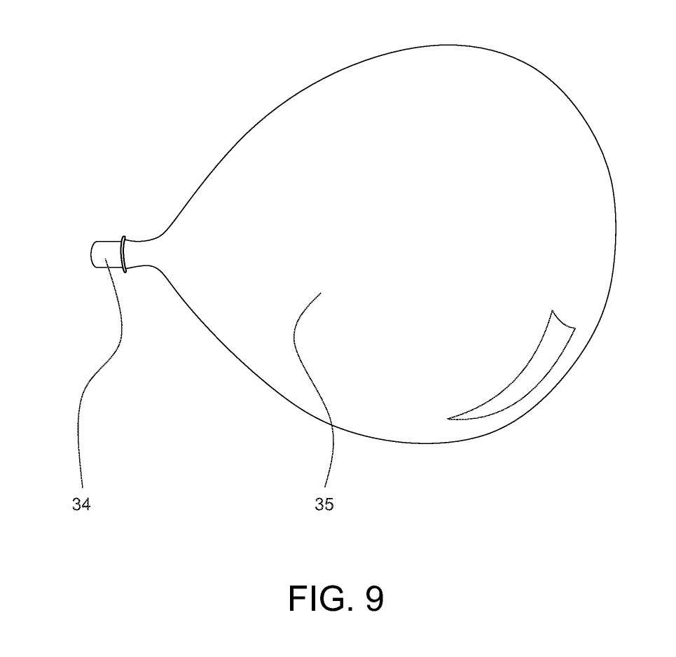

FIG. 9 shows that a preferred way to use the device is to use a power air supply (not shown) in conjunction with a one-way valve 34, such as the standard and well known Schrader valve, to inflate the object such as balloon 35. Schrader valves have been available for more than 100 years and are the standard automobile tire valve. Of course, other one-way valves may be used as long as they are of comparable size and can be engaged by the neck of a typical balloon or other inflatable object.

It is contemplated that the device of this concept could be sold as a kit or unit of board 11, a multiplicity (such as 100, for example) of objects, such as balloons, and a dozen or so valves. In operation, a dozen balloons would be fitted with a dozen valves and the balloons would be inflated. Without removing the valves, the balloons would be mounted to board 11 by urging the rounded body of the object through an opening such as opening 22 from the back of the board, until the object is positively engaged by fingers 23, as shown in FIG. 5. If desired, as an alternative to leaving the valve in the neck of the balloon until the balloon is burst, the open end of the balloons could be secured/sealed by a string tied around the neck after the balloon is inflated, or the neck itself could be knotted to retain the air in the balloon.

The device as shown and described herein, can be used in conjunction with any appropriate projectile launching device, including air soft guns, B-B guns, bow and arrows, or thrown knives. Any other types of projectiles that can easily, visibly engage the inflated objects, such as balloons, and will cause an inflated balloon to burst upon forceful contact could also be used with this device.

After some or all of the objects in board 11 have been hit, or possibly exploded, the balloon residue and the valves, are cleaned up and retrieved. The valves are then recycled to another set of balloons.

In addition to balloon-exploding games and target practice for training of any type, the described apparatus can be applicable for many uses, including practice for battle reenactments.

Because of the positive engagement of objects such as balloons in the openings in board 11, this device can be used outdoors because the positions of balloons in board 11 will not be affected by light to moderate winds. Of course, the device shown and described here may be used indoors.

What is claimed is:

1. A mounting board for a plurality of objects, the mounting board comprising:
a board having a front surface and a back surface;
a plurality of openings through said board, each opening having a predetermined diameter and having a plurality of projections extending into the openings, each opening being configured to receive and retain a flexible, expanded object; and
a size gauge having an opening slightly larger in diameter than are the openings in said board.

2. The mounting board of claim 1, wherein each of said plurality of projections comprises a flexible finger.

3. The mounting board of claim 2, wherein each said finger extends into the opening a distance of about three to about six percent of the diameter of the opening.

4. The mounting board of claim 1, wherein said target board is a relatively rigid single panel.

5. The mounting board of claim 1, wherein said target board comprises a plurality of panels configured to fold upon each other to form a flat, compact mounting board.

6. The mounting board of claim 5, wherein said mounting board comprises a pair of panels.

7. The mounting board of claim 2, wherein said fingers are configured to flex toward said front surface when engaged by a force from said back surface.

8. A kit for retaining a plurality of items, the kit comprising:
a board;
a plurality of openings through said board, each opening having a predetermined diameter and having a plurality of projections extending into the openings;
a size gauge having an opening slightly larger in diameter than are the openings in the board;
a multiplicity of unexpanded items; and
a plurality of one-way valves.

9. The kit of claim 8, wherein said board comprises a plurality of panels configured to fold upon each other to form a flat, compact board.

10. The kit of claim 8, wherein said valves are Schrader valves.
